(19) United States
(12) Patent Application Publication
(10) Pub. No.: US 2006/0177299 A1
(43) Pub. Date: Aug. 10, 2006

(54) Method and apparatus for preserving semi-manufactured heat pipe

(75) Inventor: Hul-Chun Hsu, Taichung City (TW)

Correspondence Address: HDSL, 4331 STEVENS BATTLE LANE, FAIRFAX, VA, 22033, US

(73) Assignee: JAFFE LIMITED

(21) Appl. No.: 11/302,278

(22) Filed: Dec. 14, 2005

(30) Foreign Application Priority Data
Feb. 4, 2005 (TW) 094103813

(51) Int. Cl. B65G 67/16

(52) U.S. Cl. 414/804

(57) ABSTRACT

A method and an apparatus for preserving semi-manufactured heat pipes. The method is to store the semi-manufactured heat pipes into an enclosed chamber. The chamber is first evacuated and then introduced with protective air, so as to preserve the quality of the semi-manufactured heat pipes stored therein.

### BACKGROUND OF THE INVENTION

The present invention relates generally to a method and an apparatus for preserving semi-manufactured heat pipes, and more particularly to a method and an apparatus that can maintain the cleanness of the semi-manufactured heat pipes after a temporary discontinuation of manufacturing process.

In general, the fabrication of heat pipes requires many different steps, such as cleaning, annealing, filling working fluid, removing non-condensed vapor, and sealing the heat pipe. For this reason, the heat pipes are mostly manufactured in a clean room, so as to prevent the semi-manufactured heat pipes from being exposed to air and being damaged, when the production line is temporarily stopped or staying overnight. Otherwise, the full cycle of manufacturing process should be completed without any disruption.

However, for many unpredictable reasons, a temporary discontinuation of the production line is inevitable. Therefore, the heat pipes are often manufactured in a clean room. The high cost for establishing a clean room and the inconvenience of personnel access thereto are reflected to the retail price of the heat pipes. Consequently, the thus manufactured heat pipes are incapable of standing out from the current price war.

In light of the above, the inventor of the present invention has devoted himself to the study of possible solutions to the aforementioned drawbacks. Finally, a new method and apparatus has been developed.

### BRIEF SUMMARY OF THE INVENTION

The present invention is to provide a method and an apparatus for preserving semi-manufactured heat pipes without the need of a clean room. The semi-manufactured heat pipes are thus prevented from being contaminated by the environment, when the manufacturing process is temporarily discontinued. Therefore, the quality of the semi-manufactured heat pipes is preserved.

Accordingly, the method for preserving semi-manufactured heat pipes of the present invention includes the following steps. First, the semi-manufactured heat pipes are stored in an enclosed chamber. Then, the chamber is evacuated, and introduced with a protective air. In this manner, the cleanness of the semi-manufactured heat pipe after a temporary discontinuation of the manufacturing process is maintained.

Furhtermore, the apparatus for preserving semi-manufactured heat pipes of the present invention includes a box, which has a hollow preservation chamber formed therein, for storing the semi-manufactured heat pipe therein, a vacuum unit and an air supply unit disposed outside of the box. The vacuum unit and the air supply unit are communicably connected to the preservation chamber via a passageway.

### BRIEF DESCRIPTION OF THE DRAWINGS

FIG. 1 is a flow diagram illustrating a method for preserving semi-manufactured heat pipes of the present invention.

FIG. 2 illustrates the usage of an apparatus for preserving semi-manufactured heat pipes of the present invention.

FIG. 3 illustrates the usage of an apparatus for preserving semi-manufactured heat pipes of the present invention.

### DETAILED DESCRIPTION OF THE INVENTION

In order to better understanding the features and technical contents of the present invention, the present invention is hereinafter described in detail by incorporating with the accompanying drawings. However, the accompanying drawings are only for the convenience of illustration and description, no limitation is intended thereto.

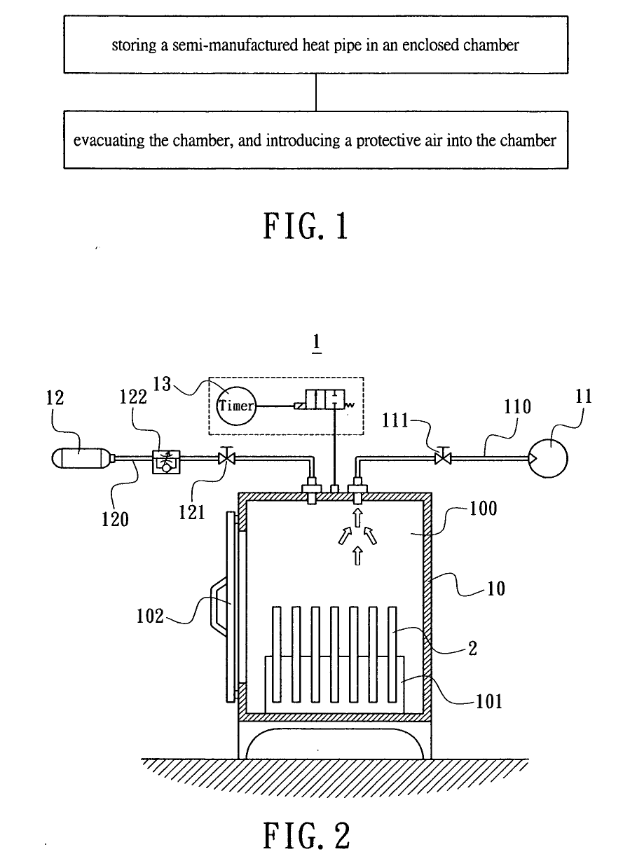

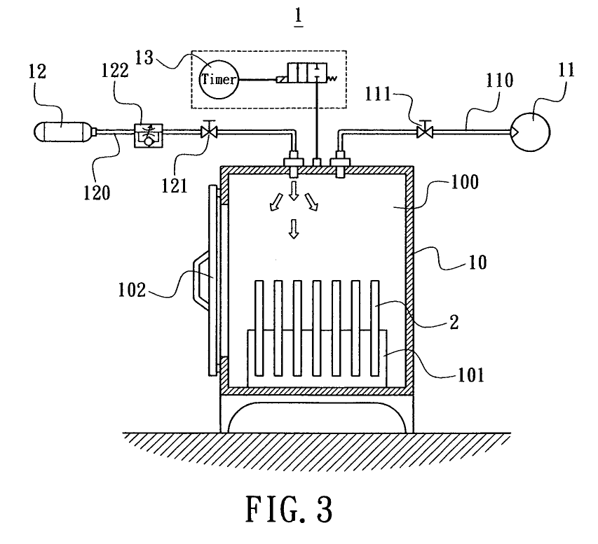

Referring to FIG. 1, FIG. 2 and FIG. 3, a method and an apparatus for preserving semi-manufactured heat pipes are illustrated. The primary purpose of the present invention is to provide a method and an apparatus for preserving semi-manufactured heat pipes, so as to prevent the heat pipes from being exposed to the environment when the manufacturing process is temporarily discontinued. The method includes the following steps.

A preprocessing step is performed. The so-called preprocessing operation includes examining the quality of the heat pipe material, the capillary structure, etc., inserting the capillary structure into the heat pipe material, and cutting the heat pipe material into a predetermined length. The heat pipe material is cleaned either before or after the preprocessing step.

An annealing step is performed after the preprocessing step. The annealing process can eliminate the internal stress of the heat pipe material, and prevent the heat pipe material from being oxidized, keeping the manufacturing process clean.

After that, the working fluid is filled into the heat pipe material. The working fluid acts as a heat transfer medium using its liquid-gas phase transition property.

Next, the non-condensed vapor in the heat pipe is removed.

Finally, the opening of the heat pipe material is sealed.

The semi-manufactured heat pipe is basically stored in an enclosed vacuum chamber. A protective gas is introduced into the vacuum chamber. The enclosed chamber is the preservation apparatus 1 of the present invention. The preservation apparatus 1 includes a box 10. A hollow storage chamber 100 is formed in the box 10. The storage chamber 100 includes a table 101, which allows the semi-manufactured heat pipes 2 to dispose thereon. A door 102 that can open and close the preservation chamber 100 is formed at one side of the preservation chamber 100. When the door 102 is closed, the preservation chamber 100 forms an secure enclosure.

A vacuum unit 11 and an air supply unit 12 are disposed outside of the box 10, each having a passageway 110, 120 connected with the preservation chamber 100. Both of the two passageways 110, 120 have a control switch 111, 121 to control the flow of the passageways 110, 120. In one particular embodiment, the vacuum unit 11 is a vacuum pump, which evacuates the air in the preservation chamber 100 that contains the semi-manufactured heat pipes 2. The air supply unit 12 introduces the protective air into the preservation chamber 100. The protective air can be nitrogen (N2) or argon (Ar). In addition, a flow control valve 122 is disposed on the passageway 120, thereby controlling the air flow.

Accordingly, as shown in FIG. 2, the preservation chamber 100 can be evacuated via the vacuum unit 11 after the semi-manufactured heat pipes 2 are disposed in the box 10. Later, as shown in FIG. 3, the protective air is introduced into the preservation chamber 100 via the air supply unit 12. In this manner, clean air is provided to those semi-manufactured heat pipes 2 that are stored in the preservation chamber 100, thereby keeping the semi-manufactured heat pipes clean. The quality of the semi-manufactured heat pipes can then be preserved when the manufacturing process is temporarily discontinued.

Further, since after storing the semi-manufactured heat pipes 2 in the preservation chamber 100 for a while, certain degree of gas or dirty matter will be released. Therefore, a timer 13 is further disposed to the preservation apparatus 1, so as to evacuate the protective air in the box 10 within a certain period of time, and introduce again fresh protective air into the chamber via the air supply unit 12. Consequently, the purity of the protective air in the preservation chamber 100 is maintained.

In summary, the present invention indeed satisfies the patentability requirements of the patent law, a grant of letters patent therefor is thus respectfully requested.

Since, any person having ordinary skill in the art may readily find various equivalent alterations or modifications in light of the features as disclosed above, it is appreciated that the scope of the present invention is defined in the following claims. Therefore, all such equivalent alterations or modifications without departing from the subject matter as set forth in the following claims is considered within the spirit and scope of the present invention.

What is claimed is:

1. A method for preserving a semi-manufactured heat pipe, comprising the steps of:
a) storing a semi-manufactured heat pipe in an enclosed chamber; and
b) evacuating the chamber, and introducing a protective air into the chamber;
whereby the cleanness of the semi-manufactured heat pipe after a temporary discontinuation of the manufacturing process is maintained.

2. The method as recited in claim 1, wherein step a) further comprises the steps of preprocessing the heat pipe, annealing the heat pipe, filling a working fluid into the heat pipe, removing air contained in the heat pipe, and sealing the heat pipe.

3. The method as recited in claim 1, wherein the protective air is nitrogen or argon.

4. The method as recited in claim 1, further comprising: c) periodically evacuating the protective air in the chamber and introducing fresh protective air into the chamber.

5. An apparatus for preserving a semi-manufactured heat pipe, which is used to store the semi-manufactured heat pipe therein, the apparatus comprising a box, which has a hollow preservation chamber formed therein, a vacuum unit and an air supply unit disposed outside of the box, the vacuum unit and the air supply unit being communicably connected to the preservation chamber via a passageway.

6. The apparatus as recited in claim 5, wherein the preservation chamber comprises a door formed on one side thereof.

7. The apparatus as recited in claim 5, further comprising a timer valve disposed outside of the box.

8. The apparatus as recited in claim 5, wherein the preservation chamber comprises a table disposed therein.

9. The apparatus as recited in claim 5, wherein the vacuum unit comprises a vacuum chamber.

10. The apparatus as recited in claim 5, wherein a control switch is connected to passageway of the vacuum unit and the air supply unit.

11. The apparatus as recited in claim 5, wherein a flow control valve is disposed to the passageway of the air supply unit.
